(19) United States
(12) Patent Application Publication
(10) Pub. No.: US 2026/0141018 A1
(43) Pub. Date: May 21, 2026

(54) AI BASED INFORMATION PROCESSING APPARATUS FOR DECISION MAKING SUPPORT, INFORMATION PROCESSING METHOD, AND PROGRAM

(71) Applicant: NEC Corporation, Tokyo (JP)

(72) Inventor: Ryutaro DOI, Tokyo (JP)

(73) Assignee: NEC Corporation, Tokyo (JP)

(21) Appl. No.: 19/368,089

(22) Filed: Oct. 24, 2025

(30) Foreign Application Priority Data
Nov. 21, 2024 (JP) 2024-203023

(51) Int. Cl. G06F 17/11

(52) U.S. Cl. CPC G06F 17/11

(57) ABSTRACT

An information processing apparatus according to the present disclosure includes: a searching unit configured to perform a solution search for a variable included in an optimization problem; a state recording unit configured to record a state change of the variable in a process of the solution search; and a fixing unit configured to fix the variable included in the optimization problem based on the state change. The searching unit is configured to perform a solution search to the optimization problem with the variable fixed.

### INCORPORATION BY REFERENCE

This application is based upon and claims the benefit of priority from Japanese patent application No. 2024-203023, filed on Nov. 21, 2024, the disclosure of which is incorporated herein in its entirety by reference.

### TECHNICAL FIELD

The present disclosure relates to an information processing apparatus, an information processing method, and a program.

### BACKGROUND ART

As a method for solving real-world problems, it is common practice to transform them into the Ising model format, which formulates energy in combinatorial optimization problems, and then solve them. For example, it is practiced to formulate the energy of an optimization problem in the form of QUBO (Quadratic Unconstrained Binary Optimization) and solve by simulated annealing.

Meanwhile, as the problem scale of a combinatorial optimization problem increases, the number of solution states becomes enormous, which may require a prolonged time for solution. On the other hand, in certain cases, some variables in a problem can be fixed; for example, Patent Literature 1 describes solving by fixing binary variables in various patterns.
Patent Literature 1: Japanese Unexamined Patent Application Publication No. JP-A 2021-131723

### SUMMARY

However, as described in Patent Literature 1, even when some variables are fixed in a combinatorial optimization problem, there exist numerous fixed patterns, and as a result, a problem remains that the solution time is prolonged.

Accordingly, an object of the present disclosure is to solve the aforementioned issue of a prolonged solution time in a constraint-based combinatorial optimization problem.

An information processing apparatus as an aspect of the present disclosure includes: a searching unit configured to perform a solution search for a variable included in an optimization problem; a state recording unit configured to record a state change of the variable in a process of the solution search; and a fixing unit configured to fix the variable included in the optimization problem based on the state change. The searching unit is configured to perform a solution search to the optimization problem with the variable fixed.

Further, an information processing method as an aspect of the present disclosure includes: performing a solution search for a variable included in an optimization problem; recording a state change of the variable in a process of the solution search; fixing the variable included in the optimization problem based on the state change; and performing a solution search to the optimization problem with the variable fixed.

Further, a program as an aspect of the present disclosure includes instructions for causing an information processing apparatus to execute processes to: perform a solution search for a variable included in an optimization problem; record a state change of the variable in a process of the solution search; fix the variable included in the optimization problem based on the state change; and perform a solution search to the optimization problem with the variable fixed.

Configured as described above, the present disclosure can inhibit the prolongation of the solution time in a combinatorial optimization problem.

### BRIEF DESCRIPTION OF THE DRAWINGS

FIG. 1 is a block diagram showing an example of a configuration of an information processing apparatus according to the present disclosure;

FIG. 2 is a flowchart showing an example of processing operation of the information processing apparatus according to the present disclosure;

FIG. 3 is a diagram showing an example of a state of processing by the information processing apparatus according to the present disclosure;

FIG. 4 is a block diagram showing an example of a hardware configuration of an information processing apparatus according to the present disclosure; and

FIG. 5 is a block diagram showing an example of a configuration of the information processing apparatus according to the present disclosure.

### EXAMPLE EMBODIMENT

### First Example Embodiment

A first example embodiment of the present disclosure will be described with reference to the drawings. The drawings may be related to any example embodiment.

### [Configuration]

An information processing apparatus 10 in the present disclosure is used, as an example, to solve a preset constraint-based combinatorial optimization problem by simulated quantum annealing (simulated annealing). Here, an example of a method for solving a constraint-based combinatorial optimization problem by simulated quantum annealing will be described.

A constraint-based combinatorial optimization problem is a problem in which an objective function and a constraint condition are set and a solution that minimizes the objective function while satisfying the constraint condition is to be found. Then, a constraint-based combinatorial optimization problem can be transformed into, for example, a formulated model such as the Ising model and the QUBO (Quadratic Unconstrained Binary Optimization) model as shown by Formula 1 and Formula 2. In the constraint-based combinatorial optimization problem, an energy value E of the optimization problem can be represented using objective function terms (first and second terms) and constraint condition terms (third and fourth terms) as shown by Formula 1, and can be integrated into one model as shown by Formula 2.

$$E = {\sum }_{i} {\sum }_{j} {J}_{ij}^{′} {s}_{i} {s}_{j} + {\sum }_{i} {h}_{i}^{′} {s}_{i} + {\sum }_{i} {\sum }_{j} {\hat{J}}_{ij} {s}_{i} {s}_{j} + {\sum }_{i} {\hat{h}}_{i}^{′} {s}_{i} \qquad [ Formula 1 ]$$

$$E = {\sum }_{i} {\sum }_{j} {J}_{ij} {s}_{i} {s}_{j} + {\sum }_{i} {h}_{i} {s}_{i} = {\sum }_{i} {\sum }_{j} {W}_{ij} {s}_{i} {s}_{j} \qquad [ Formula 2 ]$$

Here, sᵢ and sⱼ in the above formulas are variables representing the states of spins sᵢ and sⱼ, and are expressed as “−1” or “1”, or as “0” or “1”. In this example embodiment, a description will be made assuming the optimization problem is transformed into the QUBO model and the states of spins i and j are expressed as “0” or “1”. Note that i and j are the identification numbers of spins s. Further, Wᵢⱼ in Formula 2 set forth above is a weight parameter set in correspondence with each combination of spins sᵢ and sⱼ, and hereinafter it will be referred to as a QUBO matrix.

At the time of finding a spin that minimizes the energy E by simulated quantum annealing in the constraint-based combinatorial optimization problem set forth above, the state of the spin s flips from 0 to 1 or from 1 to 0, and the solution is thereby made to transition and searched for. In simulated quantum annealing, at the time of searching for the solution, it transitions at all times when the evaluation value of a neighborhood solution is good (small), while it may transition stochastically even when the evaluation value of a neighborhood solution is bad (large). The probability in this case is determined by an inverse temperature, which is the inverse of the value of a temperature parameter, so that the information processing apparatus 10 searches for the solution while increasing or decreasing the inverse temperature.

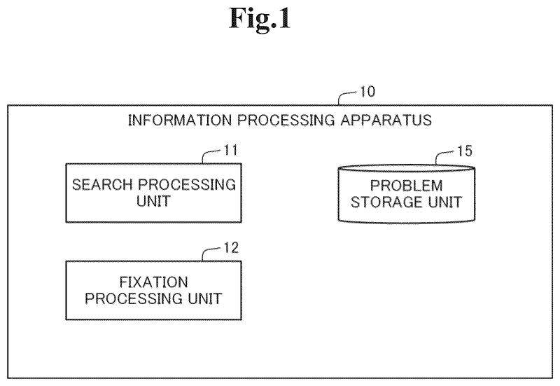

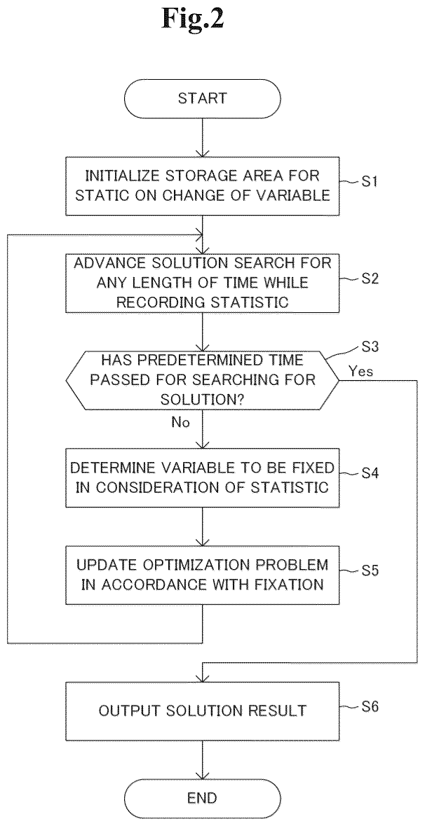

Next, an example of a configuration and operation of the information processing apparatus 10 in this example embodiment will be described in detail. FIG. 1 shows an example of the configuration of the information processing apparatus 10, and FIG. 2 shows an example of the operation of the information processing apparatus 10. The information processing apparatus 10 is configured with one or a plurality of information processing apparatuses each including an arithmetic logic unit and a memory unit. As shown in FIG. 1, the information processing apparatus 10 includes a search processing unit 11 and a fixation processing unit 12. The respective functions of the search processing unit 11 and the fixation processing unit 12 can be implemented by execution of a program stored in the memory unit designed to implement the respective functions by the arithmetic logic unit. The information processing apparatus 10 also includes a problem storage unit 15 implemented by the memory unit.

The problem storage unit 15 stores information representing a constraint-based combinatorial optimization problem to be solved. As an example, one type of constraint-based combinatorial optimization problem is known as a traveling salesman problem. A traveling salesman problem is an optimization problem to find a route with the minimum travel distance, under a constraint condition that a salesman visits all cities once given the distance between the cities.

Here, in this example embodiment, a constraint-based combinatorial optimization problem including an objective function and a constraint condition as shown by Formula 3 below (also referred to as the optimization problem hereinafter) is set and stored in the problem storage unit 15.

$$\begin{matrix}Objective function : Minimize {\sum }_{i = 1}^{n} {c}_{i} {x}_{i} \\ Constraint condition : {\sum }_{i = 1}^{n} {a}_{ij} {x}_{i} \leq {b}_{j} ( j = 1 , … , m ) \\ {x}_{i} ∈ \{ 0 , 1 \} \\ {a}_{i j} , {b}_{j} , {c}_{i} are constants\end{matrix} \qquad [ Formula 3 ]$$

Further, the problem storage unit 15 has a state storage area, which is a storage area for storing the state changes of variables during the process of solution search in the optimization problem as will be descried later. The state storage area is configured to store, as will be described later, both the state of the variables through solution search, namely, the solution state, and a counter indicating the number of changes of the variables, at each time point.

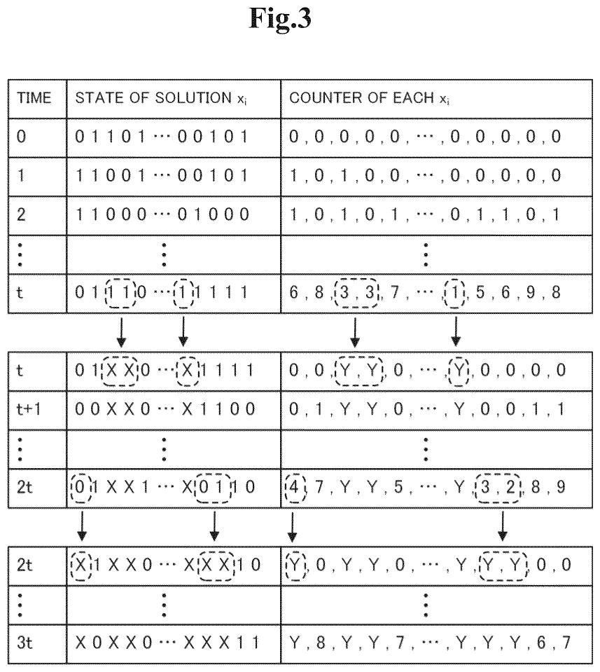

The search processing unit 11 (searching unit, state recording unit) initializes the state storage area (step S1 in FIG. 2) and performs solution search to the variables included in the optimization problem (step S2 in FIG. 2). For example, the search processing unit 11 performs solution search by simulated annealing described above. Then, during the process of solution search, the search processing unit 11 stores the state of the variables, namely, the solution state, and a counter indicating the number of changes of the variables, at each time point, into the state storage area. Here, an example of data recorded in the state storage area is shown in FIG. 3. In the example of FIG. 3, at a time point “0”, the state of the variables (xᵢ) (x₁, x₂, . . . , xₙ), namely, the solution state is “01101 . . . 00101”, and at a time point “1”, the state of the variables (xᵢ), namely, the solution state is “11001 . . . 00101”. Then, as time passes from the time point “0” to the time point “1”, the first variable x₁ changes from “0” to “1”, and the third variable x₃ changes from “1” to “0” Therefore, the numbers of changes of the first and third variables are increased by 1, and “counter” in the state storage area is stored as “1, 0, 1, 0, 0, . . . , 0, 0, 0, 0, 0,”.

The search processing unit 11 performs the solution search described above until a predetermined total search time elapses, and stores the solution state and the counter at each time point into the state storage area. In the example of FIG. 3, the total search time is assumed to be set to 3t. Then, when the total search time 3t passes (Yes at step S3 in FIG. 2), the search processing unit 11 outputs the solution state at the time as a solution result (step S6 in FIG. 2).

During a process that the search processing unit 11 is performing the solution search as described above, the fixation processing unit 12 executes a process of fixing the variable of the optimization problem to a fixed value at a predetermined timing (step S4 in FIG. 2). Then, when the variable is fixed at the predetermined timing, the search processing unit 11 updates the optimization problem in accordance with the fixation of the variable (step S5 in FIG. 2), searches for a solution to the updated optimization problem and also records both the solution state and the counter (returns to step S2 in FIG. 2).

To be specific, when a preset fixation timing is reached during the process of solution search, the fixation processing unit 12 (fixing unit) checks the number of changes of the variables xᵢ, which is the value of the counter in the state storage area, and identifies a variable xᵢ that is less than or equal to a preset threshold value. Here, it is assumed that the fixation timing is set to a time interval “t” and a threshold value is set to “4” times, and in the example of FIG. 3, a variable xᵢ such that the value of the counter is equal to or less than 4 is identified every time the time interval t pass. Therefore, first, at a time point t, a variable xᵢ such that the value of the counter is equal to or less than 4 is identified. Then, as shown by enclosing with a dotted line in the example of FIG. 3, the counter values of the third, fourth, and (n−4)th variables x₃, x₄, and xₙ₋₄ are equal to or less than 4, and the variables x₃, x₄, and xₙ₋₄ are identified and fixed. At this point, the fixation processing unit 12 fixes the values of the states of the identified variables x₃, x₄, and xₙ₋₄ at the time point t, that is, the solution values as fixed values for the variables x₃, x₄, and xₙ₋₄. As shown by enclosing with the dotted line in the example of FIG. 3, values (1 or 0), which are the solution states at time point t of the variables x₃, x₄, and xₙ₋₄, are fixed as fixed values of the respective variables x₃, x₄, and xₙ₋₄. In the example of FIG. 3, the fixed variables are expressed as “X”, and are fixed to fixed values of 1 or 0.

In the above example, a case where the fixation processing unit 12 fixes the value of a variable at the time point t, which is the fixation timing, as a fixed value for the variable as is, but a fixed value for a variable may be determined according to the value of the variable until that time, that is, according to the solution state up to that point. For example, the fixation processing unit 12 may fix, as a fixed value, the mode value of the solution state, which is the value of the variable up to the time point t that is the fixation timing. Furthermore, the fixation processing unit 12 may fix a variable as a fixed value based on a ratio that the state of the solution, which is the value of the variable up to the time point t, was a specific value. For example, since the solution state is either 1 or 0, it is possible to calculate a ratio that the value of the variable up to the time point t was 1 or 0 and then fix the variable to the value with the higher ratio. At this time, the variable may be fixed to a value that has a higher ratio that the variable is 1 or 0. In this way, the fixation processing unit 12 may fix the variable based on a predetermined statistical value of the state change of the variable, for example, fix the variable based on the number of changes of the variable, or fix the variable based on the mode value of the variable or a ratio that the variable is a specific value.

After the time point t, the search processing unit 11 updates the optimization problem in a state where the variable is fixed. For example, as shown by Formula 4 below, the search processing unit 11 updates the objective function and constraint condition of the optimization problem.

$$\begin{matrix}Objective function : Minimize {\sum }_{i ∉ \{ 3 , 4 , n - 4 \}} {c}_{i} {x}_{i} + {\sum }_{i ∈ \{ 3 , 4 , n - 4 \}} {c}_{i} \\ Constraint condition : {\sum }_{i ∉ \{ 3 , 4 , n - 4 \}} {a}_{ij} {x}_{i} + {\sum }_{i ∈ \{ 3 , 4 , n - 4 \}} {a}_{ij} \leq {b}_{j}\end{matrix} \qquad [ Formula 4 ]$$

Then, as shown in FIG. 3, the search processing unit 11 initializes the counters of the other variables xᵢ, excluding the fixed variables, to “0”, and continues to perform solution search on the updated optimization problem and record both the solution state and the counter, as described above. At this time, the fixed variable xᵢ is not subjected to solution search thereafter, and therefore the solution state remains as a fixed value, which is represented by “X” in FIG. 3. Additionally, for the fixed variable xᵢ, the counter value remains unchanged, and in FIG. 3, such variable is denoted by “Y”.

After that, when a time point 2t is reached and the next fixation timing comes, in the same manner as described above, the fixation processing unit 12 checks the number of changes of each variable xᵢ, which is the value of the counter in the state storage area, identifies a variable xᵢ that is equal to or less than the threshold value 4, and fixes the variable to a fixed value. In the example shown in FIG. 3, variables x₁, xₙ₋₂, and xₙ₋₃ are identified and formulated. Then, as shown by the following Formula 5, the search processing unit 11 updates the optimization problem in a state where the variables are fixed, initializes the counter of each remaining variable xᵢ, excluding the fixed variables, to “0”, and continues to perform solution search on the updated optimization problem and record the solution state and the counter in the same manner as previously described. In the example shown in FIG. 3, the variables x₁ and xₙ₋₃ are fixed to “0”, so that they do not appear in part of the optimization problem indicated by Formula 5.

$$\begin{matrix}Objective function : Minimize {\sum }_{i ∉ \{ 1 , 3 , 4 , n - 4 , n - 3 , n - 2 \}} {c}_{i} {x}_{i} + {\sum }_{i ∈ \{ 3 , 4 , n - 4 , n - 2 \}} {c}_{i} \\ Constraint condition : {\sum }_{i ∉ \{ 1 , 3 , 4 , n - 4 , n - 3 , n - 2 \}} {a}_{i j} {x}_{i} + {\sum }_{i ∈ \{ 3 , 4 , n - 4 , n - 2 \}} {a}_{i j} \leq {b}_{j}\end{matrix} \qquad [ Formula 5 ]$$

Subsequently, when a time point t3 is reached and the predetermined total search time passes, the search processing unit 11 outputs the solution state found through the search as a final solution. At this time, the search processing unit 11 outputs the final solution including the fixed variables, represented in a form such as “X=00110 . . . 10111”, for example.

As described above, in this example embodiment, by fixing a variable in a constraint-based combinatorial optimization problem to a fixed value, it is possible to achieve reduction of the solution time.

It should be noted that, in the above example, a threshold value for the number of changes required to fix the variable xᵢ at the fixation timing is exemplified as four times; however, such number may be any value, and it is permissible for the number to vary in accordance with the duration of the solution search. For example, at the early stage of the solution search, that is, at an early time when significant changes of variables are expected due to simulated annealing, a large threshold value may be used; as the time for solution search progresses, the threshold value may be reduced; and at the late stage of the solution search, that is, at a late time when it is expected that changes of the variables stabilize, the threshold value may be set even lower than before.

Further, although the above example illustrates the case where the fixation timing is at time intervals t, it is not limited to fixed time intervals and may also be at varying time intervals. For example, as described above, at the early stage of the solution search, that is, at the early time that the variables are expected to significantly change, a longer time interval may be set, and as the time for solution search progresses, the time interval may gradually be shortened, and in the final stage of the solution search, that is, at the late time that changes in the states of the variables are expected to stabilize, the time interval may be set even shorter than the preceding intervals.

Further, in the above description, the fixation processing unit 12 fixes a variable to a fixed value based on the state change of the variable, but the other variable may be fixed to a fixed value in accordance with the content of an optimization problem in which a predetermined variable has been fixed. For example, when a constraint condition is a one-hot constraint in which only one of five variables is “1”, if a predetermined single variable is fixed to a fixed value “1” based on the state change of the variables, then, according to the constraint condition, the remaining four variables can each be fixed to a fixed value “0”. For example, when a constraint condition stipulates that the sum of five variables must be three or more, if predetermined two variables are fixed to the fixed value “0” based on the state changes of the variables, then it is possible to fix the remaining three variables to the fixed value “1” in accordance with the constraint condition. Thus, the fixation processing unit 12 may also fix the other variables determined by the content of the optimization problem, such as the constraint condition that certain variables have already been fixed, to fixed values.

Further, the search processing unit 11 may revert a fixed variable as described above to a variables that is not fixed. In this case, the search processing unit 11 may revert a fixed variable to an unfixed variable in accordance with the state change of the variable in the process of solution search. For example, the search processing unit 11 may revert a fixed variable to an unfixed variable in cases where, even after a certain period of solution search, there is no change in the solution state or no improvement in the solution. Then, the search processing unit 11 further performs the solution search of the variables in the optimization problem that the fixed variables are reverted to the unfixed variables.

### Second Example Embodiment

Next, a second example embodiment of the present disclosure will be described with reference to the drawings. This example embodiment shows the overview of the information processing apparatus and so forth described in the above example embodiment. The drawings may be related to any of the example embodiments.

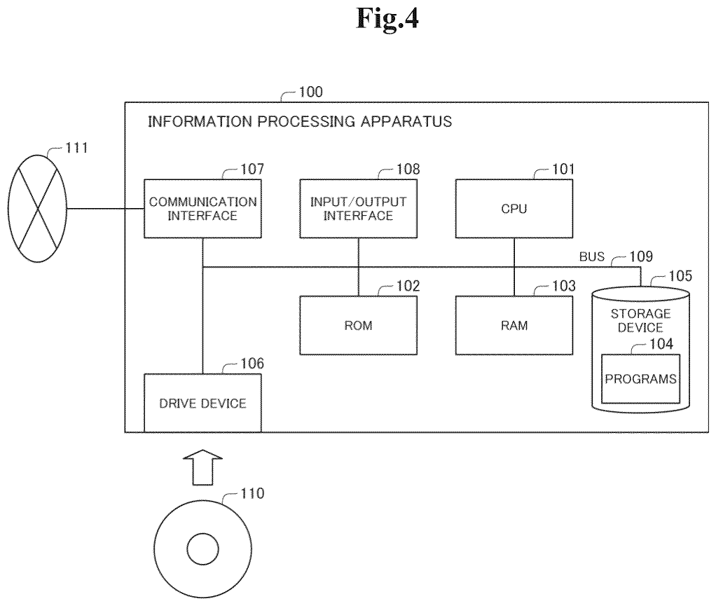

First, a hardware configuration of an information processing apparatus 100 in the present disclosure will be described. The information processing apparatus 100 is configured with a general-purpose information processing apparatus and, as an example, has the following hardware configuration as shown in FIG. 4, including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 4 illustrates an exemplary hardware configuration of the information processing apparatus serving as the information processing apparatus 100, and the hardware configuration of the information processing apparatus is not limited to the aforementioned example. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, instead of the abovementioned CPU.

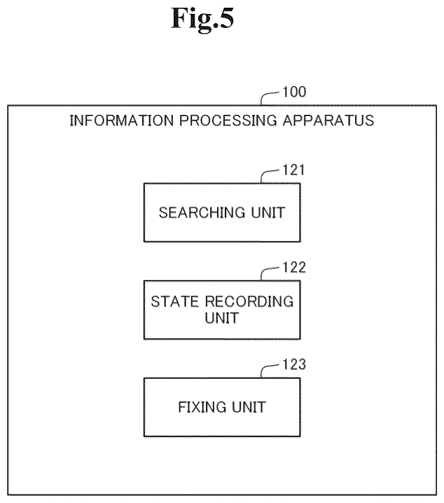

The information processing apparatus 100 can construct and include a searching unit 121, a state recording unit 122, and a fixing unit 123 shown in FIG. 5, by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110, and read out by the drive device 106 and provided to the CPU 101. However, the aforementioned searching unit 121, state recording unit 122 and fixing unit 123 may be constructed with dedicated electronic circuits designed to implement such means.

The searching unit 121 performs solution search of a variable included in an optimization problem. The state recording unit 122 records the state change of the variable in the process of the solution search. The fixing unit 123 fixes the variable included in the optimization problem based on the state change. Then, the searching unit 121 performs solution search to the optimization problem in a state where the variable is fixed.

Configured as described above, the present disclosure can inhibit prolongation of the solution time in a constraint-based combinatorial optimization problem.

At least one or more of the functions of the aforementioned searching unit 121, state recording unit 122 and fixing unit 123 may be executed by an information processing apparatus installed and connected at any location on the network, that is, may be executed by so-called cloud computing.

Further, the abovementioned programs can be stored using various types of non-transitory computer-readable mediums and provided to a computer. The non-transitory computer-readable mediums include various types of tangible storage mediums. Examples of non-transitory computer-readable mediums include a magnetic recording medium (e.g., flexible disk, magnetic tape, hard disk drive), a magneto-optical recording medium (e.g., magneto-optical disk), a CD-ROM (Read Only Memory), a CD-R, a CD-R/W, a semiconductor memory (e.g., mask ROM, PROM (programmable ROM), EROM (Erasable PROM), flash ROM, RAM (Random Access Memory)). In addition, the programs may be provided to the computer by various types of transitory computer-readable mediums. Examples of the transitory computer-readable mediums include electrical signals, optical signals, and electromagnetic waves. The transitory computer-readable mediums may provide the programs to the computer via a wired communication channel such as an electric wire and an optical fiber, or via a wireless communication channel.

Although the present disclosure has been described above with reference to the example embodiments, the present disclosure is not limited to the example embodiments described above. The configuration and details of the present disclosure can be changed in various manners that those skilled in the art can understand within the scope of the present disclosure. Then, each of the example embodiments described above can be combined with the other example embodiment as necessary.

### <Supplementary Notes>

The whole or part of the example embodiments disclosed above can be described as the following supplementary notes. Hereinafter, the overview of the configurations of an information processing apparatus, an information processing method, and a program in the present disclosure will be described. However, the present disclosure is not limited to the configurations described in the following supplementary notes.

All or some of the configurations described in Supplementary Notes 2 to 8 dependent on Supplementary Note 1 below and the functions by such configurations may be dependent on other Supplementary Notes 9 and 10 by the same dependence as Supplementary Notes 2 to 8. Furthermore, not limited to Supplementary Notes 1, 9 and 10, within the scope of the example embodiments described above, all or some of the configurations described as supplementary notes and functions by such configurations may be dependent on hardware, software, various recording means for recording software, or system.

### (Supplementary Note 1)

An information processing apparatus comprising:
a searching unit configured to perform a solution search for a variable included in an optimization problem;
a state recording unit configured to record a state change of the variable in a process of the solution search; and
a fixing unit configured to fix the variable included in the optimization problem based on the state change, wherein
the searching unit is configured to perform a solution search to the optimization problem with the variable fixed.

### (Supplementary Note 2)

The information processing apparatus according to supplementary note 1, wherein
the fixing unit is configured to fix a predetermined variable based on a statistic of the state change of the predetermined variable.

### (Supplementary Note 3)

The information processing apparatus according to supplementary note 2, wherein
the fixing unit is configured to fix the predetermined variable based on a number of changes of a value of the predetermined variable.

### (Supplementary Note 3.1)

The information processing apparatus according to supplementary note 3, wherein
the fixing unit is configured to, when the number of changes of the value of the predetermined variable at a predetermined timing is equal to or less than a preset number of times, fix the predetermined variable in accordance with a value of the variable until then.

### (Supplementary Note 3.2)

The information processing apparatus according to supplementary note 3, wherein
the fixing unit is configured to, when the number of changes of the value of the predetermined variable at a predetermined timing is equal to or less than a preset number of times, fix the predetermined variable to a value at the timing or to a mode of the value of the variable until then.

### (Supplementary Note 3.3)

The information processing apparatus according to supplementary note 3, wherein
the fixing unit is configured to fix the predetermined variable when the number of changes of the value of the predetermined variable at a predetermined timing is equal to or less than a number of times that varies in accordance with time of the solution search.

### (Supplementary Note 4)

The information processing apparatus according to supplementary note 2, wherein
the fixing unit is configured to fix the predetermined variable based on a ratio that a value of the predetermined variable is a specific value.

### (Supplementary Note 4.1)

The information processing apparatus according to supplementary note 4, wherein
the fixing unit is configured to fix the predetermined variable to the specific value in accordance with the ratio of the value of the predetermined variable.

### (Supplementary Note 5)

The information processing apparatus according to supplementary note 1, wherein
the fixing unit is configured to change a timing to fix the predetermined variable in accordance with an elapsed time of the solution search.

### (Supplementary Note 5.1)

The information processing apparatus according to supplementary note 5, wherein
the fixing unit is configured to set an interval of a timing to fix the predetermined variable to be longer as the elapsed time of the solution search is earlier.

### (Supplementary Note 6)

The information processing apparatus according to supplementary note 1, wherein
the fixing unit is configured to fix the predetermined variable included in the optimization problem based on the state change, and also fix an other variable in accordance with a content of the optimization problem with the predetermined variable fixed.

### (Supplementary Note 6.1)

The information processing apparatus according to supplementary note 6, wherein
the fixing unit is configured to fix the other variable in accordance with a content of a constraint condition of the optimization problem with the predetermined variable fixed.

### (Supplementary Note 7)

The information processing apparatus according to supplementary note 1, wherein
the searching unit is configured to perform the solution search using a fixed variable as an unfixed variable.

### (Supplementary Note 8)

The information processing apparatus according to supplementary note 1, wherein
the searching unit is configured to perform the solution search using a fixed variable as an unfixed variable in accordance with the state change of the variable in the process of the solution search.

### (Supplementary Note 9)

An information processing method comprising:
performing a solution search for a variable included in an optimization problem;
recording a state change of the variable in a process of the solution search;
fixing the variable included in the optimization problem based on the state change; and
performing a solution search to the optimization problem with the variable fixed.

### (Supplementary Note 10)

A program comprising instructions for causing an information processing apparatus to execute processes to:
perform a solution search for a variable included in an optimization problem;
record a state change of the variable in a process of the solution search;
fix the variable included in the optimization problem based on the state change; and
perform a solution search to the optimization problem with the variable fixed.

### REFERENCE SIGNS LIST

10 information processing apparatus
11 search processing unit
12 fixation processing unit
15 problem storage unit
100 information processing apparatus
101 CPU
102 ROM
103 RAM
104 programs
105 storage device
106 drive device
107 communication interface
108 input/output interface
109 bus
110 storage medium
111 communication network
121 searching unit
122 state recording unit
123 fixing unit

1. An information processing apparatus comprising:
at least one memory storing processing instructions; and
at least one processor configured to execute the processing instructions to:
perform a solution search for a variable included in an optimization problem;
record a state change of the variable in a process of the solution search;
fix the variable included in the optimization problem based on the state change, and furthermore
perform a solution search to the optimization problem with the variable fixed.

2. The information processing apparatus according to claim 1, wherein the at least one processor is configured to execute the processing instructions to
fix a predetermined variable based on a statistic of the state change of the predetermined variable.

3. The information processing apparatus according to claim 2, wherein the at least one processor is configured to execute the processing instructions to
fix the predetermined variable based on a number of changes of a value of the predetermined variable.

4. The information processing apparatus according to claim 3, wherein the at least one processor is configured to execute the processing instructions to
when the number of changes of the value of the predetermined variable at a predetermined timing is equal to or less than a preset number of times, fix the predetermined variable in accordance with a value of the variable until then.

5. The information processing apparatus according to claim 3, wherein the at least one processor is configured to execute the processing instructions to
when the number of changes of the value of the predetermined variable at a predetermined timing is equal to or less than a preset number of times, fix the predetermined variable to a value at the timing or to a mode of the value of the variable until then.

6. The information processing apparatus according to claim 3, wherein the at least one processor is configured to execute the processing instructions to
fix the predetermined variable when the number of changes of the value of the predetermined variable at a predetermined timing is equal to or less than a number of times that varies in accordance with time of the solution search.

7. The information processing apparatus according to claim 2, wherein the at least one processor is configured to execute the processing instructions to
fix the predetermined variable based on a ratio that a value of the predetermined variable is a specific value.

8. The information processing apparatus according to claim 7, wherein the at least one processor is configured to execute the processing instructions to
fix the predetermined variable to the specific value in accordance with the ratio of the value of the predetermined variable.

9. The information processing apparatus according to claim 1, wherein the at least one processor is configured to execute the processing instructions to
change a timing to fix the predetermined variable in accordance with an elapsed time of the solution search.

10. The information processing apparatus according to claim 9, wherein the at least one processor is configured to execute the processing instructions to
set an interval of a timing to fix the predetermined variable to be longer as the elapsed time of the solution search is earlier.

11. The information processing apparatus according to claim 1, wherein the at least one processor is configured to execute the processing instructions to
fix the predetermined variable included in the optimization problem based on the state change, and also fix an other variable in accordance with a content of the optimization problem with the predetermined variable fixed.

12. The information processing apparatus according to claim 11, wherein the at least one processor is configured to execute the processing instructions to
fix the other variable in accordance with a content of a constraint condition of the optimization problem with the predetermined variable fixed.

13. The information processing apparatus according to claim 1, wherein the at least one processor is configured to execute the processing instructions to
perform the solution search using a fixed variable as an unfixed variable.

14. The information processing apparatus according to claim 1, wherein the at least one processor is configured to execute the processing instructions to
perform the solution search using a fixed variable as an unfixed variable in accordance with the state change of the variable in the process of the solution search.

15. An information processing method comprising:
performing a solution search for a variable included in an optimization problem;
recording a state change of the variable in a process of the solution search;
fixing the variable included in the optimization problem based on the state change; and
performing a solution search to the optimization problem with the variable fixed.

16. A non-transitory computer-readable storage medium storing a program, the program comprising instructions for causing an information processing apparatus to execute processes to:
perform a solution search for a variable included in an optimization problem;
record a state change of the variable in a process of the solution search;
fix the variable included in the optimization problem based on the state change; and
perform a solution search to the optimization problem with the variable fixed.
